(19) United States
(12) Patent Application Publication
(10) Pub. No.: US 2009/0300748 A1
(43) Pub. Date: Dec. 3, 2009

(54) RULE COMBINATION IN A FIREWALL

(75) Inventors: David Diehl, Minneapolis, MN (US); Scott DeLoach, Margate, FL (US); Jaideep Roy, Boca Raton, FL (US)

Correspondence Address: SCHWEGMAN, LUNDBERG & WOESSNER, P.A., P.O. BOX 2938, MINNEAPOLIS, MN, 55402, US

(73) Assignee: Secure Computing Corporation, san jose, CA (US)

(21) Appl. No.: 12/131,698

(22) Filed: Jun. 2, 2008

(51) Int. Cl. G06F 21/00

(52) U.S. Cl. 726/11

(57) ABSTRACT

A firewall system comprises a rule management tool that is operable to evaluate a rule set for rules that may be merged, present selected rules that can be merged to an administrator, along with an indication of any change in function of the resulting merged rule, and receive input from the administrator indicating whether to merge the selected rules.

### FIELD OF THE INVENTION

The invention relates generally to managing rule sets, and more specifically in one embodiment to combining rules in a firewall.

### LIMITED COPYRIGHT WAIVER

A portion of the disclosure of this patent document contains material to which the claim of copyright protection is made. The copyright owner has no objection to the facsimile reproduction by any person of the patent document or the patent disclosure, as it appears in the U.S. Patent and Trademark Office file or records, but reserves all other rights whatsoever.

### BACKGROUND

Computers are valuable tools in large part for their ability to communicate with other computer systems and retrieve information over computer networks. Networks typically comprise an interconnected group of computers, linked by wire, fiber optic, radio, or other data transmission means, to provide the computers with the ability to transfer information from computer to computer. The Internet is perhaps the best-known computer network, and enables millions of people to access millions of other computers such as by viewing web pages, sending e-mail, or by performing other computer-to-computer communication.

But, because the size of the Internet is so large and Internet users are so diverse in their interests, it is not uncommon for malicious users or pranksters to attempt to communicate with other users' computers in a manner that poses a danger to the other users. For example, a hacker may attempt to log in to a corporate computer to steal, delete, or change information. Computer viruses or Trojan horse programs may be distributed to other computers, or unknowingly downloaded or executed by large numbers of computer users. Further, computer users within an organization such as a corporation may on occasion attempt to perform unauthorized network communications, such as running file sharing programs or transmitting corporate secrets from within the corporation's network to the Internet.

For these and other reasons, many corporations, institutions, and even home users use a network firewall or similar device between their local network and the Internet. The firewall is typically a computerized network device that inspects network traffic that passes through it, permitting passage of desired network traffic based on a set of rules.

Firewalls perform their filtering functions by observing communication packets, such as TCP/IP or other network protocol packets, and examining characteristics such as the source and destination network addresses, what ports are being used, and the state or history of the connection. Some firewalls also examine packets traveling to or from a particular application, or act as a proxy device by processing and forwarding selected network requests between a protected user and external networked computers.

The firewall typically controls the flow of network information by monitoring connections between various ports, sockets, and protocols, such as by examining the network traffic in a firewall. Rules based on socket and other information are used to selectively filter or pass data, and to log network activity. Firewall rules are typically configured to identify certain types of network traffic that are to be prohibited or that should have certain other restrictions applied, such as blocking traffic on ports known to be used for file sharing programs while virus scanning any data received over a traditional FTP port.

But, the number of rules needed to configure a firewall to handle the large variety of network traffic that is often present in even a small office can be daunting to manage. Hundreds or even thousands of rules are sometimes applied, with additional complexity in that rules are often processed in order such that the order in which rules are listed can affect the rules applied.

### SUMMARY

Various example embodiments of the invention comprise a firewall system and a firewall rule management tool that are operable to evaluate a rule set for rules that may be merged, present selected rules that can be merged to an administrator, along with an indication of any change in function of the resulting merged rule, and receive input from the administrator indicating whether to merge the selected rules.

### BRIEF DESCRIPTION OF THE FIGURES

FIG. 1 shows an example network including a firewall, as may be used to practice some embodiments of the invention.

FIG. 2 is a simplified rule set that may be combinable, consistent with an example embodiment of the invention.

FIG. 3 is a simplified graphical representation of a rule space used to derive and facilitate understanding of rule combinations, consistent with an example embodiment of the invention.

FIG. 4 is a screen shot of an administrator tool operable to facilitate combination of firewall rules, consistent with an example embodiment of the invention.

FIG. 5 is a screen shot of an administrator tool operable to provide an administrator information relating to proposed rules, and to allow the administrator to accept or decline proposed rule changes, consistent with an example embodiment of the invention.

FIG. 6 is a screen shot of an administrator tool operable to facilitate rule action conflict resolution, consistent with an example embodiment of the invention.

### DETAILED DESCRIPTION

In the following detailed description of example embodiments of the invention, reference is made to specific examples by way of drawings and illustrations. These examples are described in sufficient detail to enable those skilled in the art to practice the invention, and serve to illustrate how the invention may be applied to various purposes or embodiments. Other embodiments of the invention exist and are within the scope of the invention, and logical, mechanical, electrical, and other changes may be made without departing from the subject or scope of the present invention. Features or limitations of various embodiments of the invention described herein, however essential to the example embodiments in which they are incorporated, do not limit the invention as a whole, and any reference to the invention, its elements, operation, and application do not limit the invention as a whole but serve only to define these example embodiments. The following detailed description does not, therefore, limit the scope of the invention, which is defined only by the appended claims.

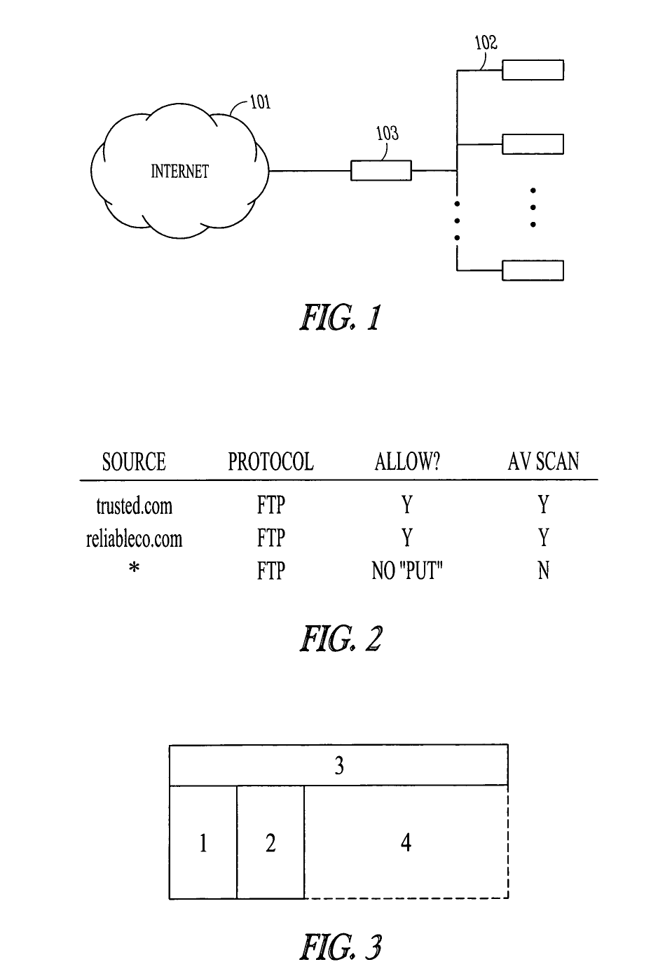

FIG. 1 illustrates a typical computer network environment, including a public network such as the Internet at 101, a private network 102, and a computer network device operable to provide firewall and intrusion protection functions shown at 103. In this particular example, the computer network device 103 is positioned between the Internet and the private network, and regulates the flow of traffic between the private network and the public network.

The network device 103 is in various embodiments a firewall device, and intrusion protection device, or functions as both. A firewall device or module within the network device provides various network flow control functions, such as inspecting network packets and dropping or rejecting network packets that meet a set of firewall filtering rules. As described previously, firewalls typically perform their filtering functions by observing communication packets, such as TCP/IP or other network protocol packets, and examining characteristics such as the source and destination network addresses, what ports are being used, and the state or history of the connection. Some firewalls also examine packets traveling to or from a particular application, or act as a proxy device by processing and forwarding selected network requests between a protected user and external networked computers. Firewalls often use “signatures” or other characteristics of undesired traffic to detect and block traffic that is deemed harmful or that is otherwise undesired.

Firewalls typically use sets of rules to filter traffic, such that what happens with any particular element of network data is dependent on how the rule set applies to that particular data. For example a rule blocking all traffic to port 6346 will block incoming traffic bound for that port on a server within the protected network, but will not block other data going to the same server on a different port number. The order of rules also plays a role in operation, such that if a prior rule says to allow all traffic from a particular range of IP addresses irrespective of the destination IP address or port, the incoming connection request to port 6346 will be allowed based on the IP address rule being processed before the port 6346 rule.

The firewall administrator responsible for configuring the firewall and managing the rule set balances trust, firewall performance, and rule set size and manageability in determining how to configure firewall rules to best suit a particular network environment. As the number of rules grows into the hundreds or even larger in some cases, the administrator's ability to efficiently manage the rule set and understand its operation is hindered.

In some circumstances, rules can be combined to reduce the number of rules that need to be managed in a set, but combination of rules can be logically difficult. As has been previously discussed, the order of two or more separate rules can influence which rule is applied to certain network traffic, and it is not always possible to create a single rule that behaves the same as a series of ordered rules. Also, combination of rules can be nearly impossible if the exact same filtering results are required, given that the scope of individual rules may not perfectly complement other rules in such a way that the rules can be combined and achieve exactly the same filtering result.

Consider as an example a first rule that says to allow but virus scan all FTP traffic coming from countries outside the United States, and a second rule that says to allow all FTP traffic coming from the United Kingdom (.uk). These rules cannot be simply combined while achieving the same result, as the rules don't require virus scanning FTP traffic from the United Kingdom currently. The most logical combined rune would allow FTP traffic from outside the United States but require virus scanning, thereby adding a virus scanning requirement to FTP traffic from the United Kingdom where no such requirement existed before. The administrator must recognize that this possible rule combination exists, and recognize and accept the change in combined rule behavior to combine even these simple two rules.

Duplicate rules, seemingly different rules that function to have similar effect except for one or two parameters, and combined rule sets such as from multiple firewalls into a single enterprise management system can make these problems even more complex. Further, addition of new rules to a rule set, such as to facilitate operation of new technologies or applications or to handle new threats, can significantly change the operation of other rules in the rule set. The administrator is responsible for deciding where to place the rule in the ordered rule list, and determining whether and how the new rule will interact with any of the hundreds of other rules likely already in the rule set.

Some embodiments of the invention address this issue by providing an administrator tool that facilitates management of a rule set. In one embodiment, the administrator tool is a software application that provides a user interface that enables the administrator to perform various functions, including searching for interaction of a given rule with other rules in the rule set, identifying rules that may be combinable with no change in rule function, and identifying rules that may be combinable but that will result in a change in rule function along with identifying the functional difference between the current rules and the combined rule.

This is achieved in a more detailed example by using the parameters of the rule space, including source, destination, user, service, enterprise firewall ID, and other such parameters to identify rules that may interact or be combinable. FIG. 2 illustrates rule combination, consistent with an example embodiment of the invention. In the example shown, three FTP rules are candidates for combination, including rules allowing FTP traffic from trusted sources trusted.com and reliableco.com. In many embodiments, these trusted sources would be identified by IP address or IP address range. Rules for both trusted sources here allow FTP traffic, but require a virus scan. A third rule allows FTP traffic from all other sources except for “put” functions that may be used to upload a file, such that unknown sources can log on and download but not upload files. No antivirus scan is therefore required for the third rule.

While it becomes evident that the first two rules can be easily combined, as they are identical except for a single parameter that does not overlap or interact in identifying two different connection sources, the third rule is distinctly different. Both the actions allowed and the virus scanning parameter are different, as is the lack of a specific, identified source. Further, the order of the third rule is important, as the rule should be processed only after the first two rules, so that the trusted sources are allowed to FTP and “put” files to the servers protected by the firewall.

Adding the third rule to the other two to form a combined rule will therefore require that the firewall behaves differently for at least some connections. In this example, it may be acceptable to allow FTP access including upload capability for all users, requiring anti-virus scanning for uploads only. The administrator may deem this a reasonable risk to take, or may decide the change to rule set functionality is unacceptable and only allow combination of the first two rules while declining to allow the third rule to be combined with the first two.

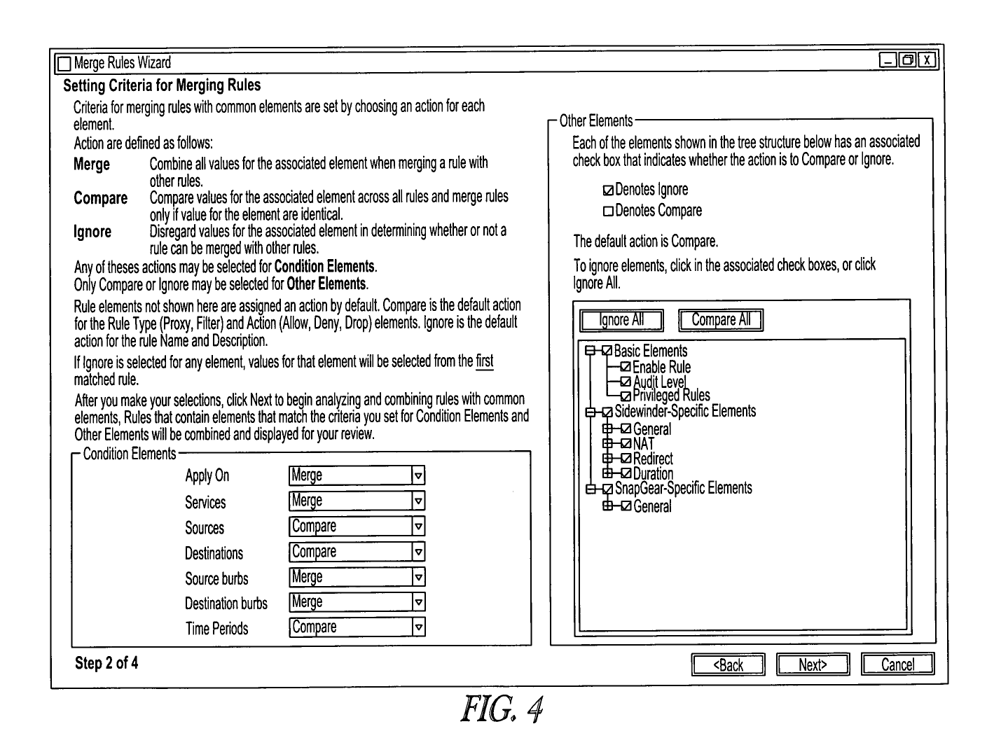

The changed rule condition space can be envisioned as a condition space having a number of dimensions equal to the number of rule parameters, in which the rules can be graphically represented by multi-dimensional rectangles, as is illustrated in the example in FIG. 3. Combination of rules with no change in functionality can be achieved where a single rectangle can be used to entirely enclose two previous rule-space rectangles with no empty space, such as by combining rules 1 and 2 in FIG. 3 or FIG. 2. But, when a rule such as rule 3 is combined with the other rules, a single rectangle can no longer exactly and only enclose the included rules. In this example, extra space in the rectangle is represented by the empty space identified in FIG. 3 as “difference rule” 4, which represents the effective change in function between the combined rules 1-3 and the individual rules.

One embodiment of the invention derives and presents a proposed combined rule, with or without a description of the change in function between combined rules and independent rules such as by presenting a “difference rule” as show at 4 in FIG. 3. The administrator is able to accept, alter, or decline combination of the rules, or deselect certain rules from the combined rule to achieve the reduced rule set that is desired. In some embodiments, the user is also able to choose one or more rule parameters as search criteria for rules to be combined, increasing the likelihood of finding rule combinations that will be acceptable to the administrator. Searching based on one or two parameters at a time also controls the amount of unfilled rule space likely to be found in proposed combined rules, minimizing the effective size of difference rules that must be accepted if rule combination is allowed.

A further embodiment seeks to minimize the size of the difference rule resulting from rule combinations, and presents proposed rules meeting a certain threshold for added rule space within the combined rule rectangle, presents multiple options to the administrator, or breaks proposed combined rules up into multiple proposed combined rules when appropriate to reduce the difference rule space relative to the combined rule space.

Some embodiments of a rule combination tool also restrict combination of rules that operate differently when combined than when processed in order, and can alert the administrator when a new rule can be combined with, negate, or interact with currently existing rules.

FIG. 4 is a screen shot of an administrator tool operable to facilitate combination of firewall rules, consistent with an example embodiment of the invention. The example screen shot shown illustrates how the administrator is able to select various criteria or elements for evaluating rule merge candidates, including whether to merge all values for an element when combining various rules, whether to compare values for the selected elements and merge only if the element values are identical, and whether to ignore a certain rule in determining whether a rule can be merged with other rules.

Some rule characteristics are assigned default actions in this example, and are not changeable. For example, Action element data, such as drop, allow, or deny, is compared by default as it is assumed that an administrator would not willingly combine rules that take different actions. The rule name and description fields are ignored, as the content of these fields is descriptive and meaningful matches are not likely to be found. Other conditions, such as source, destination, time period, and service are administrator-configurable, as shown in the Condition Elements box in FIG. 4. Additional, less commonly used criteria are shown in the Other Elements box, in which the administrator can use check marks to mark each of several more detailed or less commonly used elements as “ignore” or “compare”.

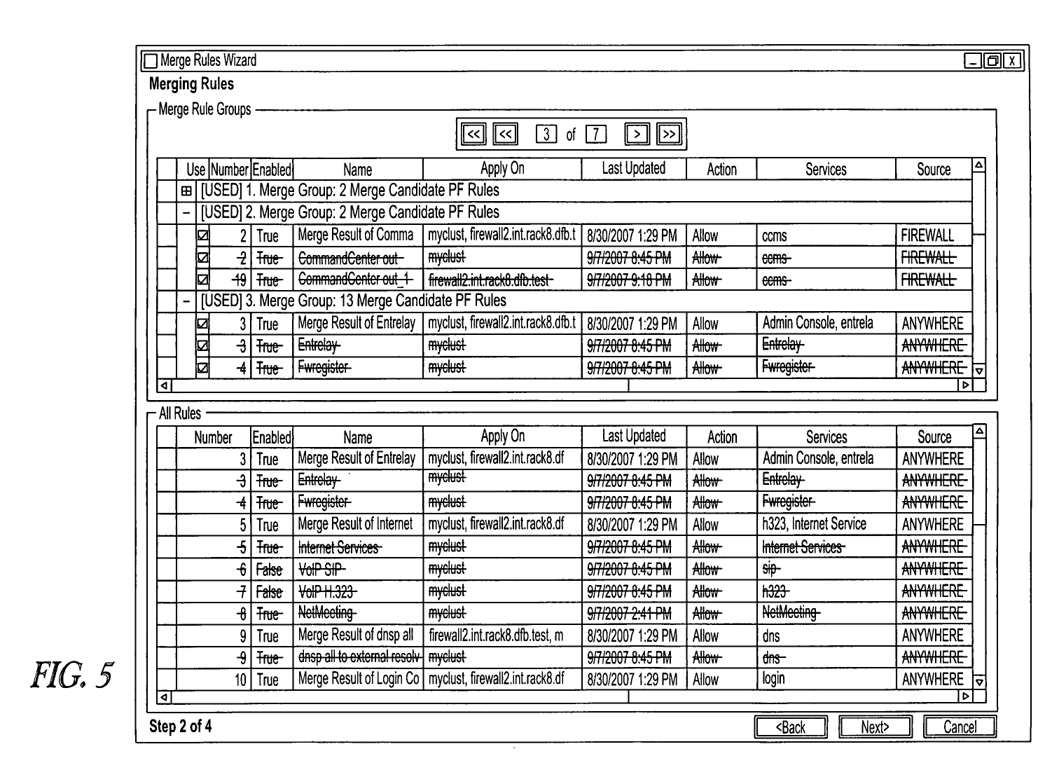

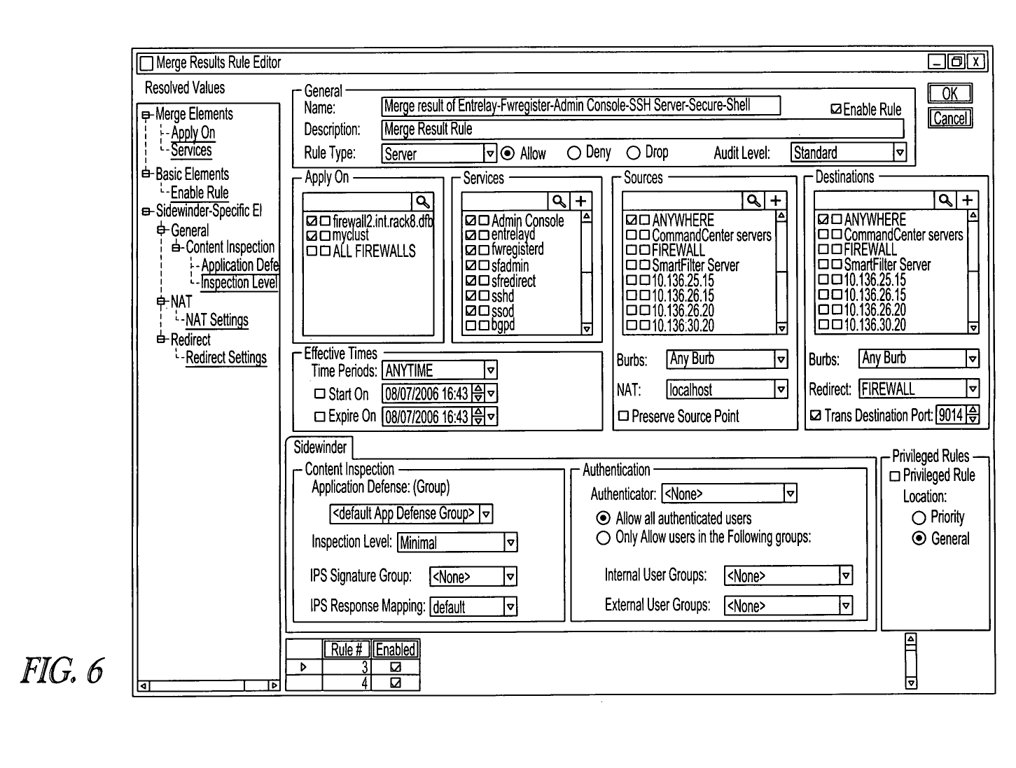

Once the administrator has selected one or more elements to be compared or merged, the next box is clicked and a rule merge comparison is run on the rule set based on the selected criteria elements. The results are presented to the administrator as groupings of rules that may be merged, such as is shown in FIG. 5. FIG. 5 is a screen shot of a rule configuration tool operable to provide information to an administrator relating to proposed rules, and to allow the administrator to accept or decline proposed rule changes, consistent with an example embodiment of the invention.

Here, rules 2 and 19 are combined, as the rules are similar but operate on different firewall devices within an enterprise. Combination of the rules is straightforward, as the “Apply On” criteria element can simply be merged to recite that the same rule is to be applied on several different systems rather than requiring multiple rules to specify the same thing. Also, a number of rules can be combined into rule 3, if the “Apply On” and “Services” fields are merged such that similar rules applied to different services on different firewall devices are combined into one or more merged rules.

If there are differences in values of other fields in the merge screen, the administrator is presented with a screen that enables review of the proposed merged rule, including the ability to accept or decline the proposed merger or alter the rule merger. FIG. 6 is a screen shot of an administrator tool operable to facilitate rule action conflict resolution, consistent with an example embodiment of the invention. Here, a merge result rule shows the criteria elements that make up the rule, including highlighting those that are selected in the proposed merged rule, and providing the administrator the option to select or deselect various element options by checking or unchecking boxes associated with the element options. For example, the administrator may choose to apply the merged rule to all firewalls rather than just the firewalls listed in the rules being merged, making application of the rule uniform across an enterprise. Similarly, the administrator may add additional services to the rule by selecting the check box next to a service that is not highlighted, or deselect a service by unchecking the box next to a service that is highlighted.

Once the user has accepted the merged rules, amended and accepted the merged rules, or declined the merged rules, the resulting rules are presented to the administrator who then gives final approval to accept the merged rule set. The merged rules then replace the combined original rules in the rule set, reducing the total number of rules and likely improving the efficiency and readability of the rule set.

The rules are managed in some embodiments as entries in a database, such as an SQL database of rule elements that can be searched based on the administrator-selected criteria to find merge candidates. In further embodiments, the same rule data is used to determine whether a new rule will interact with currently existing rules, or can be merged with currently existing rules. Rule addition is therefore handled in some embodiments by using administrator tools such as those shown in FIGS. 4-6, to attempt to efficiently merge any new rule added to the ruleset into existing rules.

Similarly, a database of rule criteria that is ordered, as are the rules in the example presented here, can be searched to determine whether a new rule or a group of rules that may be merged interact with other rules in an order-specific way, such that order dependencies can be flagged and brought to the attention of the administrator, such as by use of a special color or other marker in the rule merge tool example presented above. The administrator in some situations will likely accept the loss of order specific rule behavior and merge the rules based on a presented difference rule or other description of the order dependency, while in other situations will decline to change rule behavior by combining the order-dependent rules.

New rules may subsume or negate previous rules, or conflicting rules may be present in the ruleset, and the rule administration tool in a further embodiment is operable to help the administrator spot rules that have such rule conflicts so that the administrator can select which of the rules to apply, what order the rules should be applied, or merge the rules into a single rule if appropriate.

The examples presented here have shown how a rule merge tool in a firewall can be used to evaluate rule interaction with other rules, and facilitate merging rules and simplifying rule sets. Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the example embodiments of the invention described herein. It is intended that this invention be limited only by the claims, and the full scope of equivalents thereof.

1. A firewall system comprising a rule management tool that is operable to:
evaluate a rule set for rules that may be merged;
present selected rules that can be merged to an administrator, along with an indication of any change in function of the resulting merged rule; and
receive input from the administrator indicating whether to merge the selected rules.

2. The firewall system of claim 1, the rule management tool further operable to evaluate the rule set for rules that may be merged based on user-selected parameters.

3. The firewall system of claim 1, the rule management tool further operable to alert the administrator to order-dependent changes in the function of selected rules.

4. The firewall system of claim 1, the rule management tool further operable to automatically merge rules that do not result in a change in function when merged.

5. The firewall system of claim 1, the rule management tool further operable to indicate new rule interaction with the rule set, wherein rule interaction comprises rule order dependence with other rules, new rule negation of other rules, and new rule mergeability with other rules.

6. The firewall system of claim 1, wherein the change in function of the resulting merged rule comprises at least one of application of a merged rule to conditions that were not previously covered by the rules being merged, loss of order-dependent operational characteristics of one or more rules to be merged, and rule conflict between rules to be merged.

7. A method of managing rules in a firewall, comprising:
evaluating a rule set for rules that may be merged;
presenting selected rules that can be merged to an administrator, along with an indication of any change in function of the resulting merged rule; and
receiving input from the administrator indicating whether to merge the selected rules.

8. The method of managing rules in a firewall of claim 7, wherein evaluating the rule set for rules that may be merged comprises evaluating the rules based on user-selected parameters.

9. The method of managing rules in a firewall of claim 7, further comprising alerting the administrator to order-dependent changes in the function of selected rules.

10. The method of managing rules in a firewall of claim 7, further comprising automatically merging rules that do not result in a change in function when merged.

11. The method of managing rules in a firewall of claim 7, further comprising indicating new rule interaction with the rule set to the administrator, wherein rule interaction comprises rule order dependence with other rules, new rule negation of other rules, and new rule mergeability with other rules.

12. The method of managing rules in a firewall of claim 11, further comprising receiving input from the administrator indicating how to integrate a new rule that is indicated to interact with other rules into the rule set.

13. A machine-readable medium with instructions stored thereon, the instructions when executed operable to cause a computerized firewall system to:
evaluate a rule set for rules that may be merged;
present selected rules that can be merged to an administrator, along with an indication of any change in function of the resulting merged rule; and
receive input from the administrator indicating whether to merge the selected rules.

14. The machine-readable medium of claim 13, wherein evaluating the rule set for rules that may be merged comprises evaluating the rules based on user-selected parameters.

15. The machine-readable medium of claim 12, the instructions when executed further operable to indicate new rule interaction with the rule set to the administrator, wherein rule interaction comprises rule order dependence with other rules, new rule negation of other rules, and new rule mergeability with other rules.

16. A firewall administrator tool operable to:
evaluate a rule set for rules that may be merged;
present selected rules that can be merged to an administrator, along with an indication of any change in function of the resulting merged rule; and
receive input from the administrator indicating whether to merge the selected rules.

17. The firewall administrator tool of claim 15, further operable to evaluate the rule set for rules that may be merged based on user-selected parameters.

18. The firewall administrator tool of claim 15, further operable to alert the administrator to order-dependent changes in the function of selected rules.

19. The firewall administrator tool of claim 15, further operable to indicate new rule interaction with the rule set, wherein rule interaction comprises rule order dependence with other rules, new rule negation of other rules, and new rule mergeability with other rules.

20. A firewall administrator tool operable to:
evaluate a rule set for interaction of a new rule with rules in a rule set;
present rule interaction of the new rule with the rule set to an administrator, along with an indication of any change in function resulting from at least one of adding the new rule or merging the new rule into the rule set; and
receiving input from the administrator indicating at least one of whether to add or merge the selected rules.
